(19) United States
(12) Patent Application Publication
(10) Pub. No.: US 2012/0106954 A1
(43) Pub. Date: May 3, 2012

(54) METHOD FOR UPDATING PORTS IN A PHOTONIC-BASED DISTRIBUTED NETWORK SWITCH

(75) Inventors: Stephen M. Sohn, Shoreview, MN (US); Brian L. Uhlhorn, St. Paul, MN (US); Howard J. Schantz, Inver Grove Heights, MN (US)

(73) Assignee: LOCKHEED MARTIN CORPORATION, Bethesda, MD (US)

(21) Appl. No.: 12/916,679

(22) Filed: Nov. 1, 2010

(51) Int. Cl. H04B 10/20

(52) U.S. Cl. 398/45

(57) ABSTRACT

A photonic-based distributed network switch is described that updates independent ports of the switch in parallel based on information that flows through the ports to and from a passive photonic broadcast star. Because each port sees the same information via the passive photonic broadcast star, each port can harvest information from the data flow in parallel and update itself based on the harvested information.

### FIELD

This disclosure relates to a photonic-based distributed network switch useable in a broadcast-based photonic network.

### BACKGROUND

Conventional networks that employ commercial-off-the-shelf switches require specialized distribution protocols and/or specialized synchronization protocols to distribute routing information between switches.

### SUMMARY

A photonic-based distributed network switch is described that updates independent ports of the switch in parallel based on information that flows through the ports to and from a passive photonic broadcast star. Because each port sees the same information via the passive photonic broadcast star, each port can harvest information from the data flow in parallel and update itself based on the harvested information.

In one embodiment, in a photonic-based distributed switch that includes a passive photonic broadcast star and a plurality of independent ports connected to the broadcast star, each of the ports harvests broadcast information from the broadcast star in parallel.

In another embodiment, a method comprises providing a photonic-based distributed switch that includes a passive optical star and a plurality of independent ports connected to the optical star. A data frame is directed into a first one of the ports from a source external to the distributed switch. The first port harvests information from the data frame and forwards the data frame to the optical star. The optical star then distributes the data frame to the remaining ports which harvest information from the data frame in parallel.

The harvested information can be any information that the ports may need to function correctly or utilize to improve port function(s). For example, the harvested information can relate to distribution or addressing of information to and from the respective port, thereby eliminating the need for specialized distribution protocols and/or specialized synchronization protocols. Examples of information relating to distribution or addressing includes, but is not limited to, media access control (MAC) addresses, internet protocol (IP) addresses, or Logical Link Control (LLC) information.

The harvested information can also relate to information unrelated to distribution or addressing of information, including, but not limited to, quality of service or network health. Examples of quality of service include, but are not limited to, enforcement of a bandwidth reservation policy with respect to latency per application, allocated bandwidth per application, etc., as well as bit rate, bit error rate, delay, jitter, packet dropping probability. Examples of network health includes, but are not limited to, determining if network performance is degrading because of device failure, how to perform failover, etc.

The information can be harvested from any flow of data going through the ports and the passive optical star. In one example, the data flow takes the form of discrete data packets, each data packet being constructed by combining one or more data frames. Therefore, a data packet constructed from a single data frame could also be considered or referred to as a data frame. As used herein, unless otherwise specified or defined, the terms data packet and data frame are intended to refer generally to any discrete flow of data. The data flow could also be streamed.

### DRAWINGS

FIG. 1 illustrates a known photonic-based distributed network switch that can employ the methods described herein.

FIG. 2 illustrates the operations of the ports and passive optical broadcast star of FIG. 1.

FIG. 3 illustrates one example relating to the methods described herein that includes a port forwarding table of the main logic in each port.

FIG. 4 illustrates an exemplary implementation of a port forwarding table example.

FIG. 5 illustrates an example of updating the local port forwarding table.

FIG. 6 illustrates an example of forwarding data frames to external or internal destinations.

### DETAILED DESCRIPTION

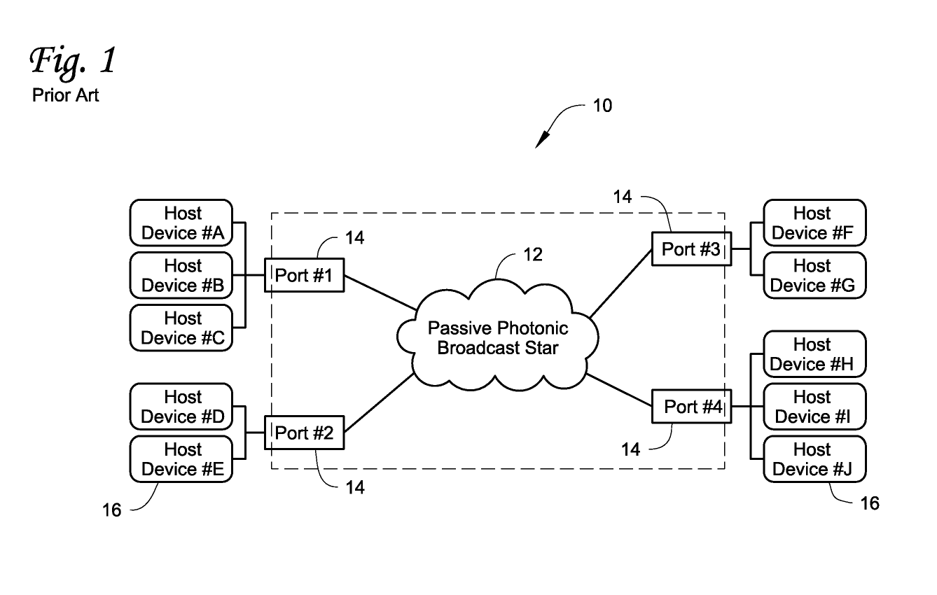

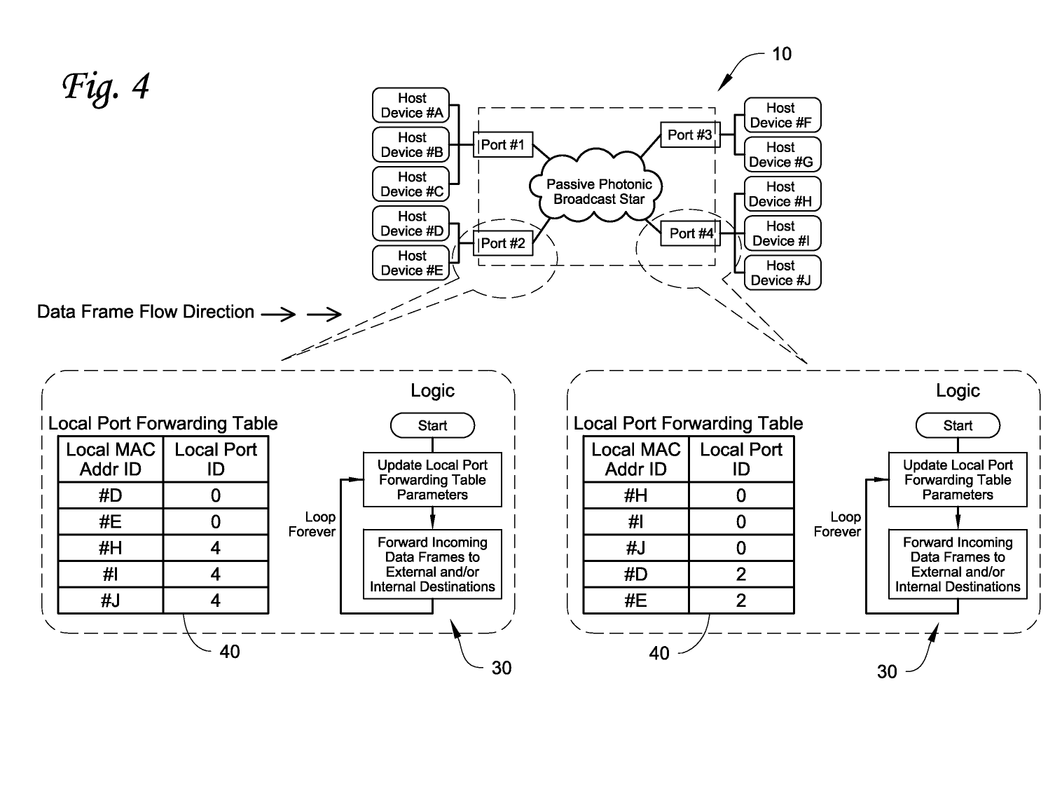

FIG. 1 illustrates a known photonic-based distributed network switch 10. The switch 10 includes a passive photonic or optical broadcast star 12. A plurality of independent ports 14 are connected to and in communication with the broadcast star 12 to route data to and receive data frames or data packets from the star 12. FIG. 4 shows four ports 14 although a larger or smaller number of ports can be utilized. The ports 14 permit connection of the switch 10 to external network-enabled devices 16. The devices 16 can be any network-enabled devices including, but not limited to, computers, network routers, network switches, storage units, printers, sensor systems, plotters, and wireless access points.

The terms data packet and data frame are used herein interchangeably and are intended to refer generally to a discrete flow of data. In addition, a data packet can be constructed from a plurality of data frames, or from a single data frame in which case the data packet can also be referred to as a data frame.

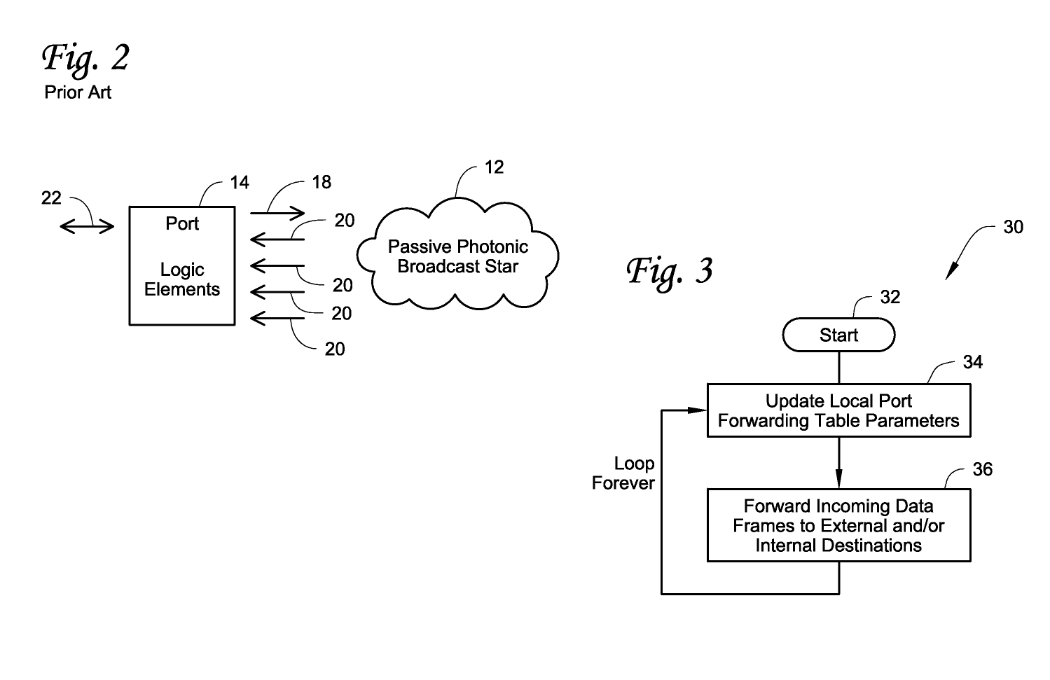

With reference to FIGS. 1 and 2, the passive optical broadcast star 12 can be, for example, a passive device that contains only passive optical components and no electronics. The broadcast star 12 replicates all data frames received from a respective port 14 on a one-way incoming channel 18 onto multiple one-way outgoing channels 20. In the illustrated example, there is one channel 18 going to the star 12 from each port 14, and P channels from the star 12 to each port, with P being the total number of ports. In FIG. 2, a similar construction is used for each port. The broadcast star 12 allows each port 14 to see all data frames for all ports 14. Therefore, any data frame that comes into, for example, port 1 from an external device is automatically received by ports 2, 3 and 4 via the star 12.

The ports 14 form the interfaces and logic that actively process and forward data frames in and from the switch 10 and connect the switch to the external devices 16. A two-way external channel 22 connects each port 14 to the external devices. The ports 14 operate independent of one another, with each port including the switching and protocol processing logic needed to perform network address resolution and data frame processing and forwarding.

The external devices 16 are connected to the ports 14 via conventional interface and protocol technology, for example, but not limited to, Ethernet. Any number of external devices can be connected to each port. Three external devices (for example computers A, B, C) are shown connected to port 1, two external devices (for example computers D and E) are connected to port 2, two external devices (for example computers F and G) are connected to port 3, and three external devices (for example computers H, I and J) are connected to port 4.

The general construction of the switch illustrated in FIGS. 1 and 2 is known. However, each port 14 is configured to update itself based on information within each data frame that enters the respective port, either directly from one of the external devices 16 connected to the respective port or from one of the data frames that enters one of the other ports and is received by the respective port via the star 12. The ports 14 update themselves by harvesting or extracting data from the data frames. This is possible since each port receives every data frame that enters the switch 10, regardless of whether the data frame directly enters the port from one of the external devices or enters the switch via one of the other ports.

The harvested information can be any information that the ports may need to function correctly or utilize to improve port function(s). Any information that can be utilized by the ports in the operation of the ports can be harvested.

For example, the harvested information can relate to distribution or addressing of data frames to and from the respective port. Examples of information relating to distribution or addressing includes, but is not limited to, media access control (MAC) addresses or internet protocol (IP) addresses.

The harvested information can also relate to information unrelated to distribution or addressing of information, including, but not limited to, quality of service or network health. Examples of quality of service include assigning priorities to data based on applications, users, or data flows, or to provide a certain level of performance to a data flow, for example a predetermined bit rate, delay, jitter, packet dropping probability and/or bit error rate. Network health can relate to, for example, the current operational state of the ports and/or the external devices 16.

To help better explain the concept of updating a port, a specific example of the ports harvesting information from a data frame will be described with respect to FIGS. 3-6. It is to be realized that the port updating concept is not limited to the example described in FIGS. 3-6 and can be applied to other port updating concepts as mentioned above.

FIGS. 3-6 illustrate the concept as applied to a port forwarding table. Each port 14 has an internal local port forwarding table and the logic used to construct and maintain the table. The port forwarding table is used to identify which external devices 16 are connected to the respective port.

FIG. 3 shows a processing loop 30 that is employed in each of the ports 14. The processing loop starts at block 32, and the first process is to update the local port forwarding table parameters 34 in the port. The next process is to forward incoming data frames to the appropriate external and/or internal destinations 36. The process then loops back to process 34 to repeat.

FIG. 4 illustrates an example of local port forwarding tables 40 relating to ports 2 and 4. In this example, the forwarding tables 40 include a column for the local MAC address identification, as well as a column for the local port identification. External devices connected to the local port are assigned a local port identification of zero (0). External devices connected to port 4 are assigned a local port identification of four (4). Similarly, external devices connected to ports 1 and 3 would be assigned suitable local port identifications (not illustrated), for example one (1) for port 1 and three (3) for port 3.

Over time, the external devices connected to each port may change, or the external devices may be connected to different ports. These changes are reflected in destination and source information contained in the data frames. This information is harvested by the ports and used by the ports to update their local forwarding tables in parallel so that each port contains an updated forwarding table.

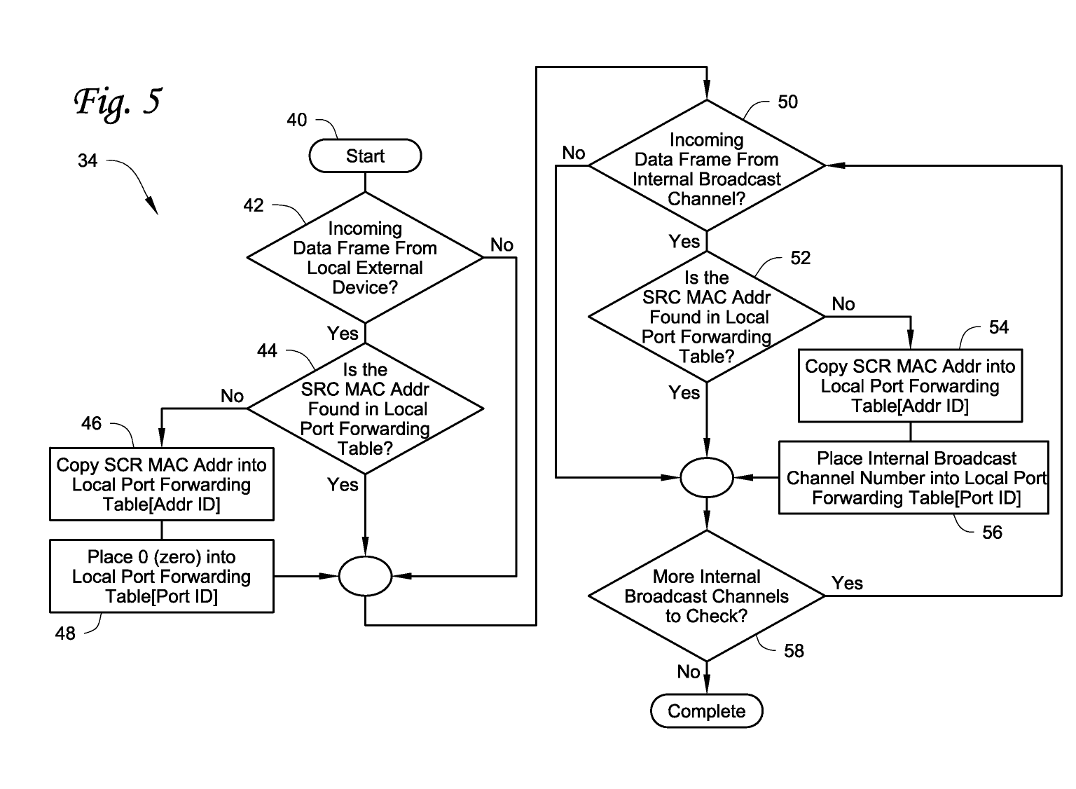

FIG. 5 illustrates the process 34 of updating the local port forwarding table parameters in each local port. The process 34 starts 40 and it is determined 42 whether or not an incoming data frame input into the local port is from a local external device. If the decision is yes, the process proceeds to step 44 where it is determined whether or not the source MAC address from the external device is found in the local port forwarding table 40. If the decision is no, the process proceeds to step 46 where the MAC address of the sending external device is harvested from the data frame and copied into the local MAC address identification column of the table 40. The local port identification is also harvested from the data frame and copied into the local port identification column of the table 40 at step 48. A local port identification of zero (0) indicates that the date frame sender is an external device.

If the determination at step 42 is no, the determination at step 44 is yes, and after step 48, the process 34 proceeds to step 50 where it is determined whether or not the incoming data frame is from an internal broadcast channel, i.e. from the star 12. If the decision is yes, the process proceeds to step 52 where it is determined whether or not the source MAC address is found in the local port forwarding table 40. If the decision is no, the process proceeds to step 54 where the source MAC address is harvested from the data frame and copied into the local MAC address identification column of the table 40. The port identification of the source is also harvested from the data frame and copied into the local port identification column of the table 40 at step 56. A port identification of non-zero (0) indicates that the data frame sender is a remote external device, i.e. not connected to the local port.

If the determination at step 50 is no, the determination at step 52 is yes, and after step 56, the process 34 proceeds to step 58 where it is determined whether there are additional internal broadcast channels to check. If the decision is yes, the process loops back to step 50. If the decision is no, the process ends.

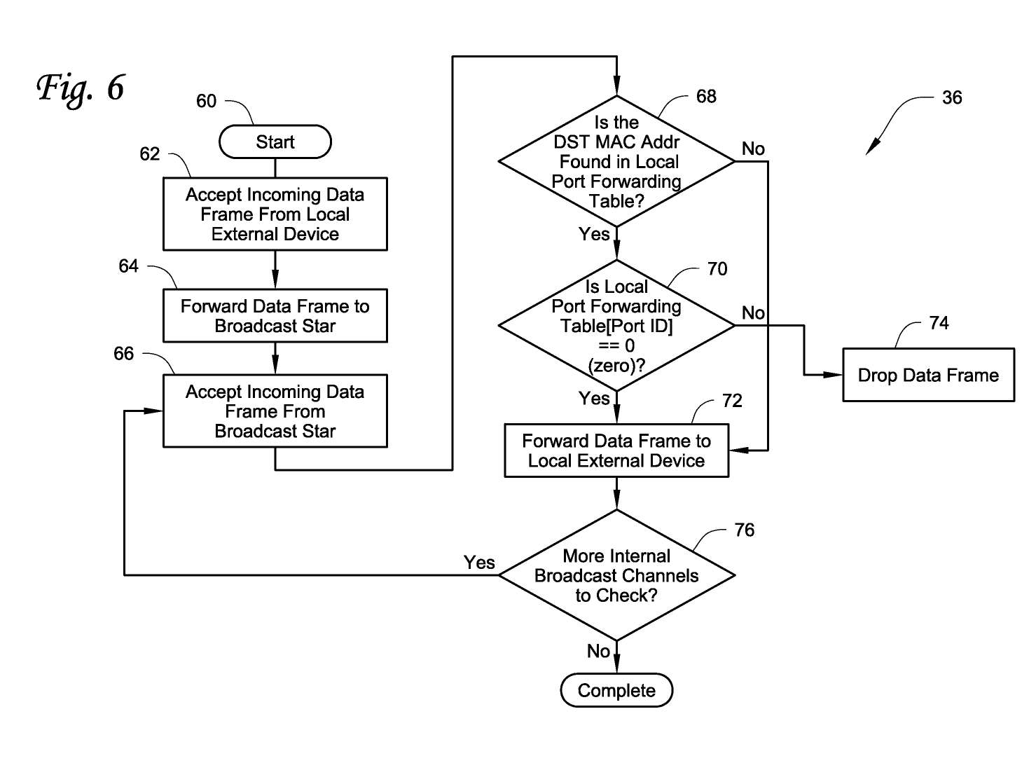

FIG. 6 illustrates the process 36 of forwarding incoming data frames to the appropriate external and/or internal destinations. The process 36 starts 60 and the data frame from an external device is accepted 62 at one of the ports and forwarded 64 to the broadcast star 12. The star 12 makes the data frame available to all of the other ports which will harvest information from the data frame to update their respective forwarding tables 40 using the process 34 discussed in FIG. 5.

At each port, the data frame is accepted 66, and then it is determined in step 68 whether or not the destination MAC address of the destination external device is in the forwarding table 40 of the respective port. If the decision is yes, the process proceeds to step 70 where it is determined whether or not the local port identification is zero (0), i.e. is the destination address of the intended external device connected to this port? A port identification of zero (0) indicates that the intended destination device is connected to the local port. If the decision is yes, the data frame is forwarded to the external device at block 72

If the determination at step 68 is no, the process skips step 70 and proceeds to step 72, where the data frame is forwarded to the destination local external device anyway. The absence of the destination MAC address from the forwarding table 40 can be resolved later.

If the determination at step 70 is no, the data frame is dropped at step 74 since a non-zero port identification would indicate that the intended destination device is not connected to the local port.

The process 36 also includes a step 76 where it is determined whether there are additional internal broadcast channels to check. If the decision is yes, the process loops back to step 66. If the decision is no, the process ends.

The above description of FIGS. 3-6 and the forwarding tables is provided to help understand the concept of the ports harvesting data from data frames. As described above, the data harvesting concept can be applied to the ports harvesting other data, either in addition to updating local port forwarding table parameters or separately from updating local port forwarding table parameters. For example, data either directly or indirectly relating to internet protocol (IP) addresses can be harvested. In addition, data either directly or indirectly relating to quality of service or network health can be harvested.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method comprising:
in a photonic-based distributed switch that includes a passive photonic broadcast star and a plurality of independent ports connected to the broadcast star, each of the ports harvesting broadcast information from the broadcast star in parallel.

2. The method of claim 1, further comprising:
each of the ports receiving a data packet from the broadcast star, and each of the ports harvesting information from the data packet in parallel.

3. The method of claim 1, further comprising:
a first one of the ports receiving a data packet from a source external to the distributed switch;
the first port harvesting information from the data packet and forwarding the data packet to the broadcast star; and
at least two additional ones of the ports receiving the data packet from the broadcast star and harvesting information from the data packet in parallel.

4. The method of claim 3, wherein each port includes switching logic and protocol processing logic to perform network address resolution and data packet processing and forwarding, and the harvested information from the data packet relates to the switching logic or the protocol processing logic.

5. The method of claim 1, wherein each port includes logic for performing a local update of the respective port based on harvested information from an incoming data packet into the respective port, and logic for forwarding the incoming data packet to an external and/or internal destination.

6. A method comprising:
providing a photonic-based distributed switch that includes a passive optical star and a plurality of independent ports connected to the optical star;
directing a data frame into a first one of the ports from a source external to the distributed switch;
the first port harvesting information from the data frame and forwarding the data frame to the optical star; and
at least two additional ones of the ports receiving the data frame from the optical star and harvesting information from the data frame in parallel.

7. The method of claim 6, wherein each port includes switching logic and protocol processing logic to perform network address resolution and data frame processing and forwarding, and the harvested information from the data frame relates to the switching logic or the protocol processing logic.

8. The method of claim 6, wherein each port includes logic for performing a local update of the respective port based on harvested information from the data frame, and logic for forwarding the data frame to an external and/or internal destination.

9. The method of claim 6, comprising updating each respective port based on the respective information harvested by each port.

10. The method of claim 6, wherein the information harvested by each port relates to one or more of a MAC address, an IP address, quality of service, or network health.

11. The method of claim 6, wherein the information harvested by each port comprises a MAC address, an IP address, or a port ID.

12. The method of claim 6, wherein the data frame includes a MAC address and a port ID.
